(19) United States
(12) Patent Application Publication
(10) Pub. No.: US 2025/0071215 A1
(43) Pub. Date: Feb. 27, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: HIKARU SUGITA, Ibaraki (JP)

(21) Appl. No.: 18/813,827

(22) Filed: Aug. 23, 2024

(30) Foreign Application Priority Data
Aug. 25, 2023 (JP) 2023-137006

(51) Int. Cl. H04N 1/00

(52) U.S. Cl. CPC H04N 1/00212; H04N 1/00225; H04N 1/00244; H04N 2201/0094

(57) ABSTRACT

An image processing apparatus includes one or more processors and one or more memories, cooperating to scan an image of a document and generate image data, transmit the generated image data to a destination specified by a user, accept a designation of a channel of a chat service, and transmit information about the designated channel and the generated image data to a server that provides the chat service, in response to the transmitting of the image data to the destination.

### BACKGROUND

### Field

The present disclosure relates to an image processing apparatus, an image processing method, and a storage medium.

### Description of the Related Art

Japanese Patent Laid-Open No. 2021-078084 (Patent literature 1) discloses an image processing apparatus that transmits image data generated by scanning an image of an original document to a chat server providing a chat service.

The image data is then uploaded and shared to a talk room of the chat service.

To store the image data transmitted by the image processing apparatus as an archive in the chat service, with the technology in Patent literature 1, it is necessary to select a talk room as the destination and input an instruction to perform transmitting after the image data has been transmitted.

### SUMMARY

The present disclosure has been made to solve the problem described above and reduce the time and effort required to share the image data transmitted by an image processing apparatus as an archive in chat services.

According to an aspect of the present disclosure, an image processing apparatus includes one or more processors and one or more memories, cooperating to scan an image of a document and generate image data, transmit the generated image data to a destination specified by a user, accept a designation of a channel of a chat service, and transmit information about the designated channel and the generated image data to a server that provides the chat service, in response to the transmitting of the image data to the destination.

Further features of the present disclosure will become apparent from the following description of exemplary embodiments with reference to the attached drawings.

### BRIEF DESCRIPTION OF THE DRAWINGS

FIG. 1 illustrates an example of a system configuration.

FIG. 2 illustrates an example of the hardware configuration of a multifunction peripheral (MFP).

FIG. 3 illustrates a configuration of a user terminal.

FIG. 4 illustrates a configuration of a messaging application server.

FIG. 5 illustrates a configuration of a tenant server.

FIG. 6 illustrates tenant information.

FIG. 7 illustrates example screens for archive transmitting destination setting of the MFP.

FIG. 8 is a sequence diagram of archive transmitting in a first embodiment.

FIG. 9 illustrates archive transmitting destination information stored in the MFP in a second embodiment.

FIG. 10 is a flowchart of an archive transmitting process performed by the MFP in the second embodiment.

FIG. 11 illustrates example screens for archive transmitting destination setting of the MFP in a third embodiment.

FIG. 12 is a flowchart of an archive transmitting process performed by the MFP in the third embodiment.

FIG. 13 illustrates a sequence of screens to execute a transmission job of the MFP.

### DESCRIPTION OF THE EMBODIMENTS

Hereinafter, embodiments of the present disclosure will be described in detail with reference to the drawings.

In the following descriptions of the embodiments, a multifunction peripheral (MFP) with print, scan, and fax functions will be used as an example of an image processing apparatus. The embodiments described herein are not intended to limit the disclosure as defined by the claims. Furthermore, not all combinations of features described in the embodiments are essential to the solution of the disclosure.

### First Embodiment

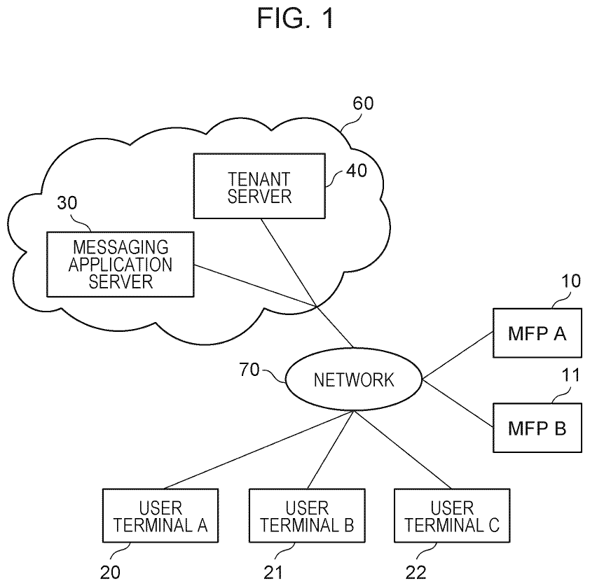

FIG. 1 illustrates an example of the overall architecture of a messaging application service according to the present disclosure. The messaging application service includes MFPs 10 and 11, which are image processing apparatuses, user terminals 20 and 22, a messaging application server 30, and a tenant server 40. The components are connected through a network 70 and are operable to communicate with each other. The network 70 is a wireless or wired network includes wide area networks (WANs) and/or local area networks (LANs). A Simple Mail Transfer Protocol (SMTP) server (not illustrated) for transmitting emails by the MFPs 10 and 11 may be connected to the network 70.

The MFPs 10 and 11 have a function of printing an image provided by the messaging application server 30 or a function of reading an original document and transmitting the generated image data to a messaging application server, which is an example of an information processing component (apparatus). In the example in the drawing, two MFPs, illustrated as the MFPs 10 and 11, are connected. However, any number of MFPs may be connected. The MFPs 10 and 11 are configured in the same manner, and the MFP 10 will be described in the following.

The user terminals 20 to 22 refer to information terminals used by users of messaging application services, such as smartphones, tablet terminals, and personal computers. In the example in the drawing, three terminals, illustrated as the user terminals 20 to 22, are connected. However, any number of user terminals may be connected. A user accesses the messaging application server 30 in the cloud by operating one of the user terminals 20 to 22 and exchanges messages with other users and executes installed applications. The user terminals 20 to 22 and the messaging application server 30 are connected to a wired or wireless communication network, and the user terminals 20 to 22 and the messaging application server 30 can individually transmit and receive data. In the present embodiment, a public network on the Internet is assumed as an example of the communication network. However, a dedicated line may be used.

The user terminals 20 to 22 may be configured in the same manner, and the user terminal 20 will be described in the following.

The messaging application server 30 is a cloud server located in a cloud 60 and is an information processing component that provides a service using a messaging application 306. Specifically, the messaging application server 30 is a server that provides and manages a chat service. The messaging application server 30 is operable to perform all operations related to the exchange of messages, such as transmitting and receiving data such as messages to and from the user terminals 20 to 22 and displaying screens for transmitting and receiving messages.

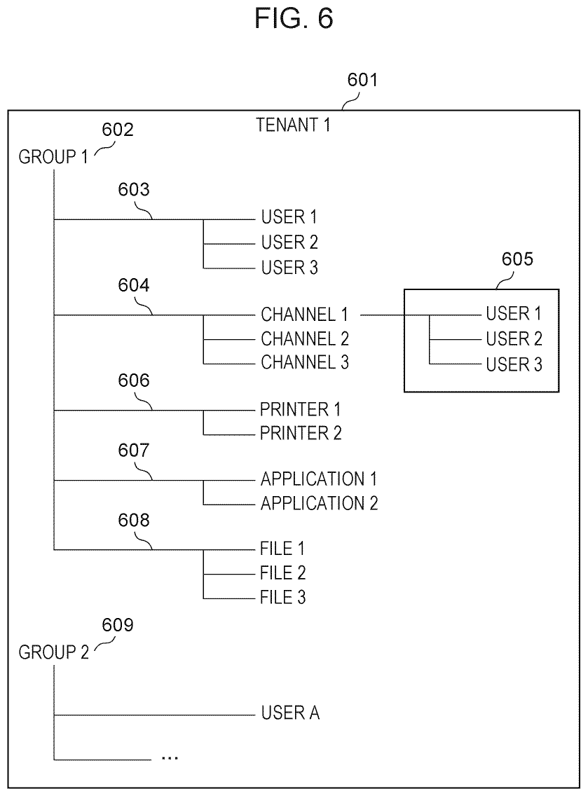

The tenant server 40 is a cloud server located in the cloud 60 and is a server that stores and provides tenant information. The tenant information stored on the tenant server 40 will be detailed in the description of FIG. 6.

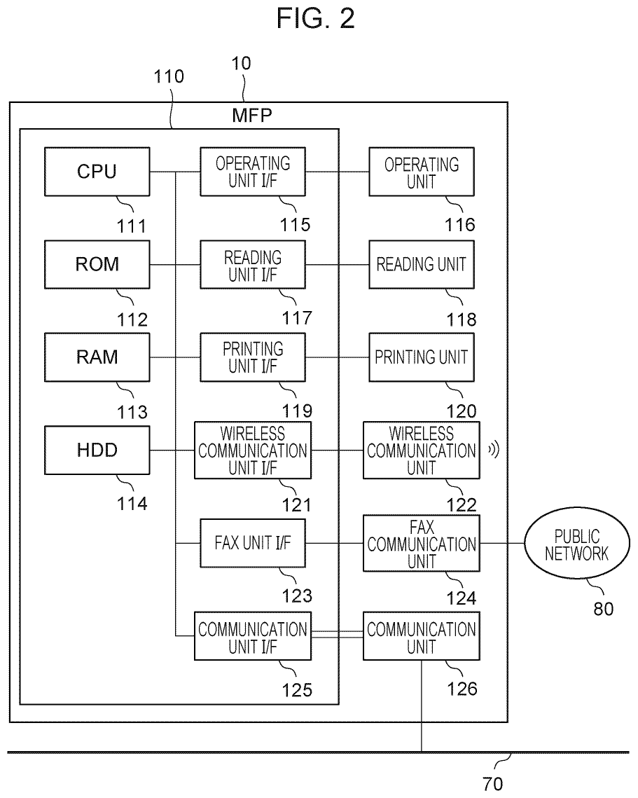

FIG. 2 illustrates an example of the hardware configuration of the MFP 10.

A control unit 110 including a central processing unit (CPU) 111 is operable to control the entire operation of the MFP 10. The CPU 111 loads control programs stored in a read-only memory (ROM) 112 or a hard disk drive (HDD) 114 onto a random-access memory (RAM) 113 and performs various controls such as reading control and printing control. The ROM 112 is operable to store the control programs that can be executed by the CPU 111. The ROM 112 is also operable to store, for example, a boot program and font data. The RAM 113 serves as the main storage memory and is used as a temporary storage area for deploying various control programs stored in a work area, the ROM 112, and the HDD 114. The HDD 114 is operable to store image data, print data, various programs, various addresses, and various setting information. The HDD 114 is a storage medium and may be, for example, a solid state drive (SSD) or embedded Multimedia Card (eMMC), instead of an HDD.

In the MFP 10 according to the present embodiment, one CPU 111 can use one memory (the RAM 113) to perform the operations illustrated in the flowcharts described later. However, this is not to be interpreted as limiting. For example, multiple CPUs, RAMs, ROMs, and HDDs may cooperate to perform the operations. Some of the operations may be performed using a hardware circuit such as an application-specific integrated circuit (ASIC) or field-programmable gate array (FPGA).

An operating unit I/F 115 is operable to connect an operating unit 116 including a display unit such as a touch panel and hard keys to the control unit 110. The operating unit 116 is operable to display information for the user and detect inputs from the user.

A reading unit I/F 117 is operable to connect a reading unit 118, such as a scanner, to the control unit 110. The reading unit 118 reads the image of an original document, and the CPU 111 generates image data. The image data generated based on the image read by the reading unit 118 can be transmitted to an external device or printed on a recording paper. The reading unit 118 is provided with an automatic document feeder (ADF). The ADF is operable to transport an original document placed on an original document tray included in the reading unit 118, and the reading unit 118 scans the original document. The ADF is able to transport multiple original documents in response to a single scanning instruction, and the reading unit 118 scans the multiple original documents.

A printing unit I/F 119 is operable to connect a printing unit 120, such as a printer, to the control unit 110. The CPU 111 can transfer the image data (print data) stored in the RAM 113 to the printing unit 120 via the printing unit I/F 119. The printing unit 120 is operable to print the image based on the transferred image data on the recording paper fed from a sheet-feeding cassette.

A wireless communication unit I/F 121 is an I/F for controlling a wireless communication unit 122 and is operable to wirelessly connect the control unit 110 to external wireless devices. The user terminals 20 to 22 may be used as the external wireless devices.

A FAX unit I/F 123 is operable to control a FAX communication unit 124 to connect the FAX communication unit 124 to a public network 80. The FAX unit I/F 123 is an I/F for controlling the FAX communication unit 124. The FAX unit I/F 123 is operable to, for example, establish connections to public networks and control the facsimile communication protocol by controlling a modem for facsimile communication or a network control unit (NCU).

A communication unit I/F 125 is operable to connect the control unit 110 to the network 70. The communication unit I/F 125, through a communication unit 126, transmits image data and various information about the inside of the device to external devices on the network 70 and receives print data and information on the network 70 from information processing components on the network 70. As methods of transmitting and receiving through the network 70, transmitting and receiving by email or transmitting files using other protocols (for example, FTP, SMB, or WEBDAV) can be performed. Image data and message data can also be transmitted and received through the network 70 via HTTP communication accessed from the user terminal 20 or the messaging application server 30. Various settings of the MFP 10 can be configured (remote UI function) by accessing the MFP 10 through the network from a web browser on the user terminal 20.

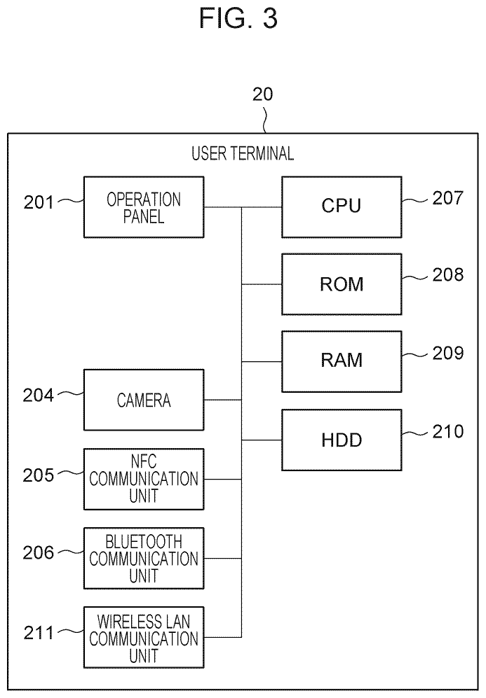

FIG. 3 illustrates an example of the hardware configuration of the user terminal 20. The user terminal 20 in the present embodiment is assumed to be a device such as a smartphone or tablet PC. However, the user terminal 20 may be any information processing component capable of connecting to the network 70 using, for example, Wi-Fi communication.

A CPU 207 is operable to read the control programs stored in a ROM 208 and performs various operations for controlling the operation of the user terminal 20. A ROM 208 is operable to store the control programs. A RAM 209 can be used as a temporary storage area that serves as, for example, the main memory and work area of the CPU 207. An HDD 210 is operable to store various kinds of data such as photographs and electronic documents.

An operation panel 201 has a touch panel function that can detect touch operations by the user and is operable to display various screens provided by the OS and an email-transmitting application. The operation panel 201 can also be used to check the information stored in the messaging application server 30. The user can input desired operation instructions to the user terminal 20 by performing touch operations on the operation panel 201. The user terminal 20 is provided with hardware keys (not illustrated). The user can input operation instructions to the user terminal 20 using these hardware keys.

A camera 204 is operable to capture images in response to image capture instructions from the user. The photographs captured by the camera 204 can be stored in a specific area of the HDD 210. It is also possible to obtain information from the QR code (registered trademark) read by the camera 204 using a program capable of analyzing QR codes.

The user terminal 20 is able to transmit and receive data to and from various peripheral devices via an NFC communication unit 205, a Bluetooth (registered trademark) communication unit 206, and a wireless LAN communication unit 211. The Bluetooth communication unit 206 of the user terminal 20 may support Bluetooth Low Energy.

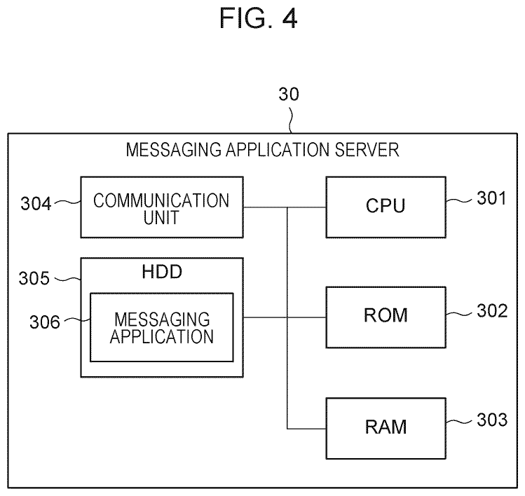

FIG. 4 illustrates an example of the hardware configuration of the messaging application server 30. A CPU 301 is operable to read the control programs stored in a ROM 302 and the messaging application 306 stored in an HDD 305 and perform various operations for controlling the operation of the messaging application server 30.

The ROM 302 stores control programs. A RAM 303 can be used as a temporary storage area that serves as, for example, the main memory and work area of the CPU 301. The HDD 305 is operable to store various kinds of data such as messages, images, channel information, and applications. Data can be transmitted and received to and from various components such as the user terminals 20 and the MFP 10 through a communication unit 304. The communication unit 304 may perform wired communication using Ethernet (registered trademark) or wireless communication such as Wi-Fi. The messaging application 306 is installed on the HDD 305 and can run on the CPU 301.

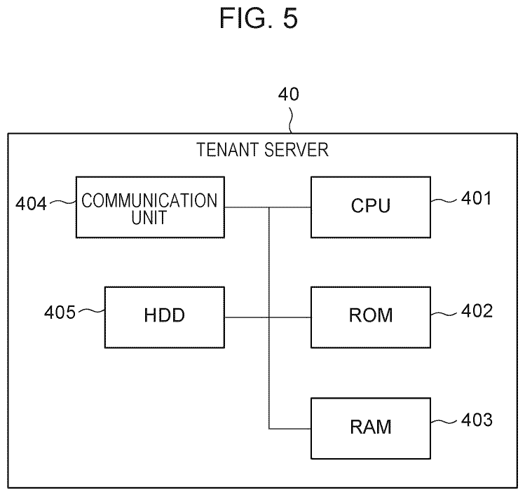

FIG. 5 illustrates an example of the hardware configuration of the tenant server 40. A CPU 401 is operable to read the control programs stored in a ROM 402 and performs various operations for controlling tenant information 601. The tenant information 601 to be stored will be described later. The ROM 402 stores control programs. A RAM 403 can be used as a temporary storage area that serves as, for example, the main memory and work area of the CPU 401. An HDD 405 is operable to store data such as the tenant information 601. Data can be transmitted and received to and from components such as the messaging application server 30 via a communication unit 404.

FIG. 6 illustrates an example of the tenant information 601 stored in the HDD 405 in the tenant server 40. The tenant information 601 contains one or more groups; in the example in FIG. 6, the tenant information 601 contains group information 602 and group information 609. In some configurations of the messaging application 306, a single item of tenant information may contain a single item of group information. In this case, the group information serves as equivalent to the tenant information 601.

Each group has information constituting the group. For example, the group of group information 602 has user information 603, channel information 604, printer information 606, companion application information 607, and file information 608.

The user information 603 indicates information of specific users belonging to the group. The channel information 604 is information for grouping the user information 603. The channel information 604 retains a list 605 that lists corresponding user information for each channel.

The printer information 606 is information for identifying individual MFPs. Applications using the group information 602 can transmit various instructions to a specific MFP by referencing this information. This printer information 606 may be an IP address or MAC address of the MFP, or a uniquely identifiable ID. The ID may be the ID issued by the MFP 10 when the information about the MFP 10 is registered in the messaging application server 30. The applications using the group information 602 can transmit commands such as print instructions to a specific MFP by referencing the printer information. The printer information 606 is linked to each group but may be linked to each channel or the companion application information described later. For example, MFP 1 may be linked to Application 1, and MFP 1 and MFP 2 may be linked to Application 2. The printer information 606 may be linked to the tenant information 601. Specifically, in the case of Tenant 1 in FIG. 6, the printers indicated by the printer information 606, which are all linked to Tenant 1, can be used.

The companion application information 607 is information for identifying companion applications that cooperate with the messaging application 306 corresponding to the group information 602.

The file information 608 is information of specific files retained in association with the group information 602. For example, in response to the file information 608 transmitted to the MFP 10, the MFP 10 can print the file. The file information 608 is linked to a specific group, but may be linked to a specific channel. For example, when a file is posted to Channel 1, which is a talk room, by a user, the file posted to Channel 1 is associated and stored. Users can check the stored files in the channel or download the stored files to the user terminal 20.

When the messaging application 306 references a user list corresponding to the tenant information 601, the messaging application 306 references the group information 602 retained in the HDD 405 of the tenant server 40 via the communication unit 304 to list the user information 603. The same applies to the channel information 604, the printer information 606, the companion application information 607, and the file information 608.

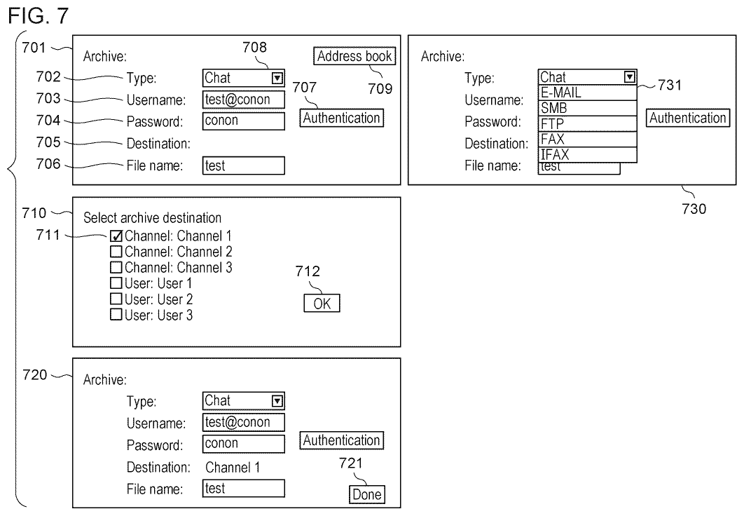

FIG. 7 illustrates a sequence of setting screens for archive transmitting, displayed using a remote UI function on the operation panel 201 of the user terminal 20. In the present embodiment, settings are configured on the user terminal 20. However, the screens in FIG. 7 may be displayed on the operating unit 116 of the MFP 10. The CPU 111 of the MFP 10 accepts the settings inputted on the setting screens in FIG. 7.

An archive destination can be specified on a setting screen 701. On this setting screen, after the MFP 10 transmits image data generated through scanning to the destination specified by the user, settings can be configured to transmit the same image data to another destination as an archive. In addition to transmitting image data, transmitting results may be transmitted as an archive.

A type field 702 displays the transmitting type for transmitting as an archive, such as chat, fax, file (SMB, FTP), or email. When the user selects a pull-down menu 708, a setting screen 730 is displayed with selection options 731. The user can select a transmitting type from options such as chat, email, SMB, FTP, FAX, and IFAX. Multiple pull-down menus may be displayed on the setting screen 701, so that multiple transmitting types may be selected. In this case, different destinations can be selected for the respective selected types.

In a username field 703, the username used for authentication can be entered. In a password field 704, the password used for authentication can be entered. The username and password entered may be authentication information for accessing a messaging application service (chat service) or passwords for accessing an SMB server, FTP server, or SMTP server. When authentication is not performed, for example, in the case of fax, the username and password fields are left blank.

In a destination field 705, the user can specify the destination for archive transmitting. The method of specifying the destination depends on the transmitting type. When chat is selected in the transmitting type field, access to the tenant server 40 is established, and a list of talk rooms that the user corresponding to the entered authentication information has joined is displayed. Displaying a list of talk rooms is achieved by the MFP 10 obtaining the channel information of the channels (talk rooms) that the user corresponding to the authentication information has joined from the messaging application server 30 or the tenant server 40 via the network 70. When the type is not chat, the destination can be entered through direct input from an input terminal such as a keyboard or soft keyboard (not illustrated), or by selecting an address from the address book stored in the HDD 114 of the MFP 10.

By selecting an authentication button 707, a setting screen 710 can be displayed. In this setting screen 710, a list of channels that the user corresponding to the user ID and PASS entered in the setting screen 701 has joined is displayed. In other words, a list of channels corresponding to the user, specifically a list of channels of the chat service (messaging application service) is displayed. Additionally, a list of other users whom the user corresponding to the user ID and PASS entered on the setting screen 701 has contacted recently is displayed. When a specific user is selected on the setting screen 710, the image data for archiving is posted to a personal talk room. A personal talk room is a talk room for users to chat one-on-one.

When an OK button 712 is selected while a checkbox 711 is selected, the transmitting destination (channel) corresponding to the selected checkbox is registered as the destination for archive transmitting. In a setting screen 720, the destination (Channel 1) set by the user is displayed in a destination field 705.

For example, when the transmitting type is fax, the destination for archive transmitting is the destination selected from the address book in the MFP10 or the destination manually entered by the user. When an address book button 709 on the setting screen 701 is selected, an address book screen (not illustrated) is displayed, and the CPU 111 can accept the user's selection of a destination. The addresses displayed on the address book screen are stored in the HDD 114 of the MFP 10. Email addresses, fax phone numbers, PC host names, IP addresses, and other specifics are stored as these addresses.

In a file name field 706, the file name of the transmitting image can be entered. The setting screen 710 is used to set, as the archive destination, chat destination information displayed when the authentication button 707 is pressed and authentication is successful.

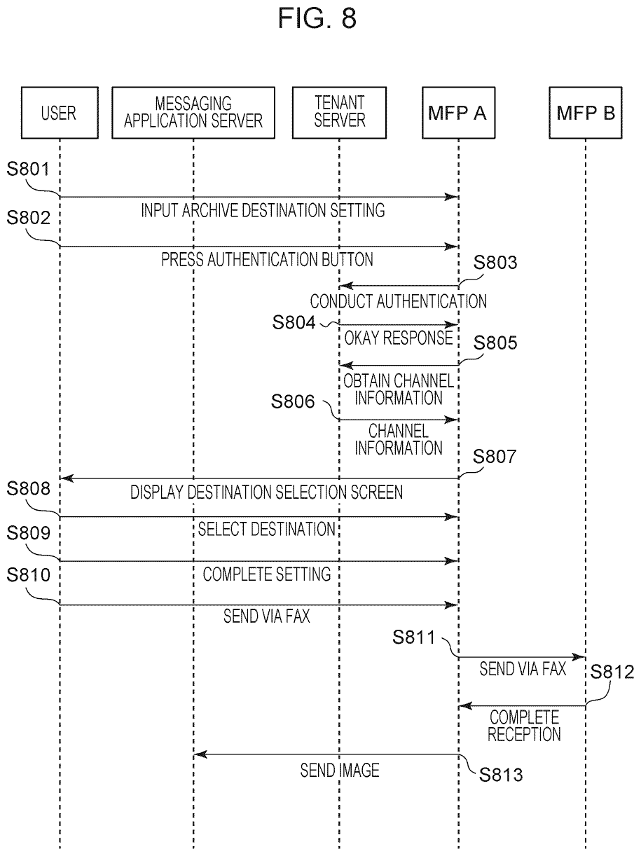

FIG. 8 is a sequence diagram of archive transmitting to a business chat server in the present embodiment. The operations (steps) of the MFP 10 in the sequence diagram of the present embodiment can be performed by the CPU 111 loading the control programs stored in the ROM 112 or the HDD 114 into the RAM 113 and executing the control programs.

In S801, the user uses the remote UI function through the operation panel 201 of the user terminal 20 and performs inputs to configure the archive destination settings on the setting screen 701.

In S802, the user presses the authentication button 707 on the operation panel 201 of the user terminal 20.

In S803, the CPU 111 transmits the username and password entered on the setting screen 701 to the tenant server 40 and provides an authentication request.

In S804, the tenant server 40 conducts authentication. When authentication is successful, the tenant server 40 transmits an OK response (access token) to the MFP 10.

In S805, the CPU 111 transmits to the tenant server 40 the access token received in S804 from the tenant server 40 and a request to obtain channel information to obtain chat destination information.

In S806, the tenant server 40 transmits channel information to the MFP 10. Here, the channel information includes the identification information (for example, name and ID) of the channel corresponding to a specific user of the authentication information entered on the setting screen 701, the names of other users corresponding to the user, the image storage destination URLs and chat posting destination URLs for the respective users. When the user has joined multiple channels, the identification information about the multiple channels can be transmitted to the MFP 10.

In S807, the CPU 111 displays the setting screen 710 based on the channel information received in S806.

In S808, the user selects a destination, such as a channel, on the setting screen 710 through the operation panel 201 of the user terminal 20.

In S809, the user presses the OK button 712 and a finish button 721 through the operation panel 201 of the user terminal 20 to complete the settings. As such, the process of setting the destination for archive transmitting is complete.

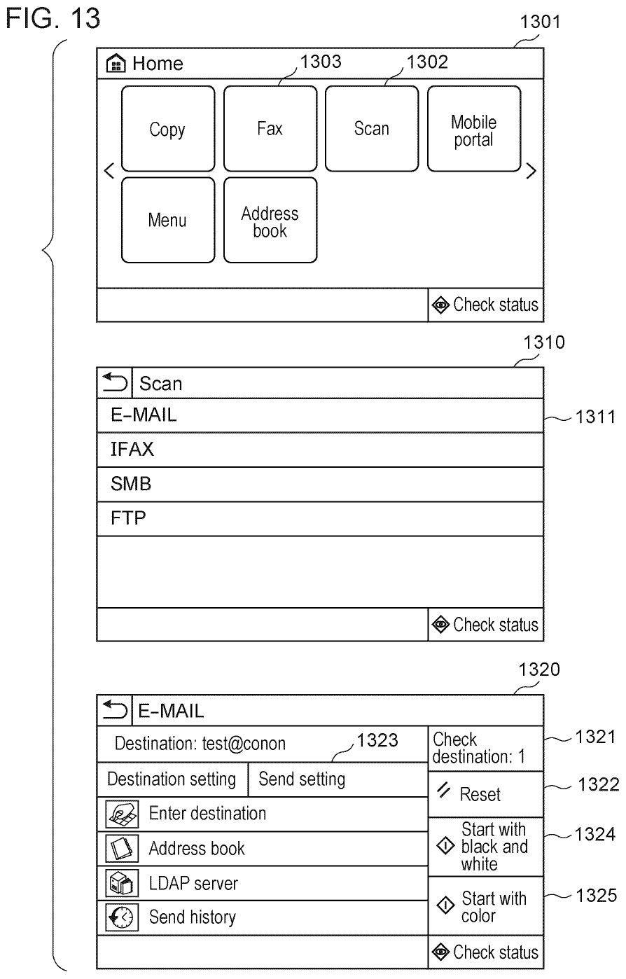

After the setting process is completed, the user executes transmitting via fax using the operating unit 116 of the MFP10 in S810 at any time. To execute transmitting via fax, it is necessary to select a fax button 1303 displayed on a home screen 1301 in FIG. 13. This home screen is a screen displayed on the operating unit 116 of the MFP 10. When this fax button 1303 is selected, a fax setting screen (not illustrated) is displayed. This fax setting screen is able to accept the transmission setting and scan setting such as fax destination, transmitting resolution, scan size, single-sided/double-sided setting. After accepting the transmission settings and the scan setting, in response to the CPU 111 accepting an instruction to execute fax, the reading unit 118 scans the original document and generates image data. The FAX communication unit 124 transmits the generated image data via fax to the destination specified on the fax setting screen. In the present embodiment, transmitting via fax is performed as an example of a transmission job. However, the transmission job can be any type of job that transmits images outside such as file transmitting (SMB, FTP) or email. The operations described above correspond to a transmitting operation performed by a first transmitting unit.

In S811, the CPU 111 performs transmitting via fax to the destination specified by the user in S810. In S812, the CPU 111 receives a fax reception completion notification.

In response to the CPU 111 determining that a fax reception completion notification has been received in S812, in S813, the CPU 111 transmits the image data that has been transmitted via fax, to the destination specified by the user as the archive destination in S808, using the access token received in S803. The description here uses the example in which chat is selected as the type of archive transmitting. Specifically, in S813, the image data is transmitted to the messaging application server 30. At this time, the identification information of the channel as the posting destination (transmitting destination) selected on the setting screen 710 is also transmitted to the messaging application server 30. Using the received image data and the identification information of the channel, the messaging application server 30 performs an operation of posting the received image data to the channel indicated by the received identification information. As such, the image data transmitted via fax or other methods can be recorded and shared as an archive in the channel of the chat service.

It may be possible that the transmitted data is not posted to the channel. In this case, the identification information of the channel selected on the setting screen 710 is transmitted to the messaging application server 30, but the image data is stored in a folder corresponding to the channel corresponding to the identification information. This folder can be referenced by accessing the messaging application server 30 through the messaging application from the terminal device. The operations described above correspond to a transmitting operation performed by a second transmitting unit.

In the above example, the reception of a fax reception completion notification is used as a trigger to perform the archive transmitting process. However, this should not be interpreted as limiting. For example, the CPU 111 may determine whether transmitting via fax has been completed and perform the archive transmitting process in response to the completion of the transmitting. Alternatively, the archive transmitting process may be started in response to the issuance of an instruction to perform transmitting via fax. As described above, the archive transmitting operation can be triggered by any action linked to the execution of the operation of transmitting image data (including transmitting via methods such as fax or email), such as the start of the operation of transmitting image data, the end of the operation of transmitting image data, the issuance of a completion notification, or the issuance of an execution instruction.

Transmitting via fax is used in the above example, but the archive transmitting process can be performed in response to the execution of transmitting via email or file transmitting.

Performing the process described above reduces the time and effort required to share the image data transmitted by an image processing apparatus as an archive in chat services.

### Second Embodiment

A second embodiment of the present disclosure will be described. In the first embodiment, the case where the archive settings are common to users of the MFP 10 has been explained. In the second embodiment, the case where the archive destination can be registered for different users operating the MFP 10 will be explained.

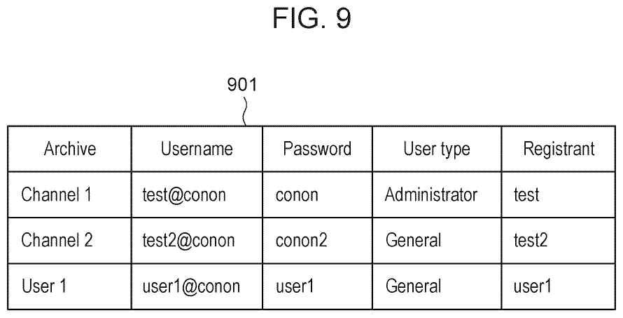

A table 901 in FIG. 9 indicates an example of registration of archive destinations for different users, stored in the HDD 114 of the MFP 10. The user who conducted the registration, the archive destination, the username, the password, and the user type are stored in association with each other.

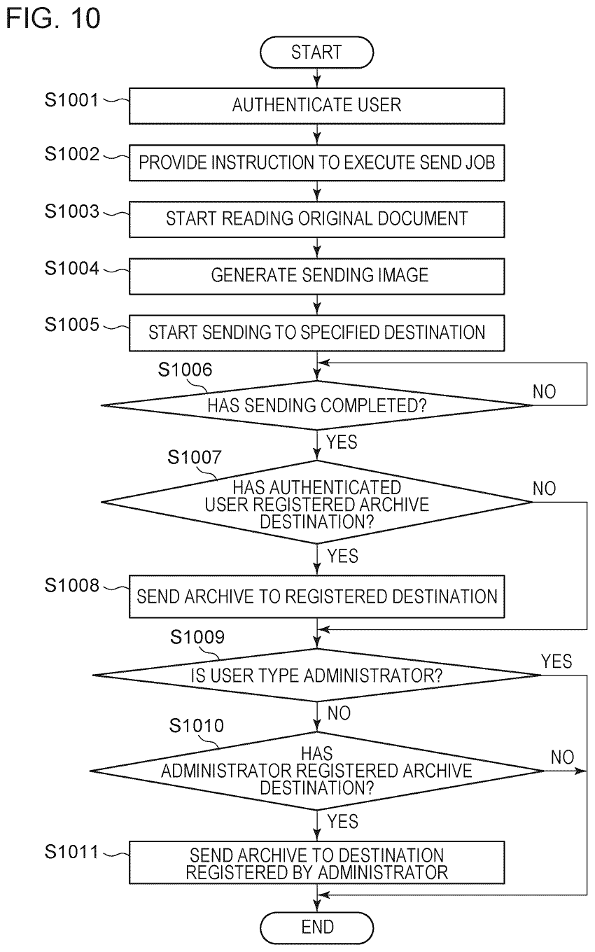

FIG. 10 is a flowchart illustrating a process when the MFP 10 performs archive transmitting to a business chat server in the present embodiment. The operations (steps) of the MFP 10 in the sequence diagram of the present embodiment can be performed by the CPU 111 loading the control programs stored in the ROM 112 or the HDD 114 into the RAM 113 and executing the control programs.

In S1001, the CPU 111 executes user authentication. In S1002, the CPU 111 accepts the scan setting, the transmission setting, and an instruction to perform transmitting from the user authenticated in S1001.

The execution of transmitting will be detailed with reference to FIG. 13 described later. In S1003, the CPU 111 controls the reading unit 118 to scan the original document.

In S1004, the CPU 111 generates image data from the original document read in S1003. In S1005, the CPU 111 transmits the generated image data to the destination specified by the user in S1002. In S1006, after transmitting is completed, the CPU 111 proceeds to S1007.

In S1007, the CPU 111 checks whether the archive transmitting destination registered by the user authenticated in S1001 is included in the archive destinations for different users stored in the HDD 114, described in FIG. 9. When the archive transmitting destination is included, the CPU 111 proceeds to S1008. When the archive transmitting destination is not included, the CPU 111 proceeds to S1009.

In S1008, the CPU 111 performs archive transmitting to the registered destination. Here, the transmitting image data is the image data transmitted in S1005.

In S1009, the CPU 111 checks whether the logged-in user is an administrator. When the logged-in user is not an administrator, the CPU 111 proceeds to S1010. When the logged-in user is an administrator, the CPU 111 ends the process.

In S1010, the CPU 111 checks whether the archive transmitting destination registered by an administrator is included in the archive destinations stored in the HDD 114 described in FIG. 9. When the archive transmitting destination is included, the CPU 111 proceeds to S1011. When the archive transmitting destination is not included, the CPU 111 ends the process.

In S1011, the CPU 111 performs archive transmitting to the destination registered by the administrator and ends the process.

The preceding discussion has described the present disclosure using an embodiment. However, the present disclosure is not limited to this embodiment, and various embodiments within the scope that do not depart from the gist of this disclosure are also included in the present disclosure.

For example, in the present embodiment, when the administrator has registered an archive destination, transmitting to the archive destination registered by the administrator is also performed after transmitting to the archive destination registered by a general user. However, it may be possible that transmitting to the administrator is not performed.

FIG. 13 illustrates a sequence of screens to execute a transmission Job displayed on the operating unit 116 of the MFP 10.

By pressing a scan button 1302 on the home screen 1301, the screen transitions to a job selection screen 1310.

The job selection screen 1310 displays a list of scan jobs supported by the MFP 10. The user selects the job that the user desires to execute. In the present embodiment, the example in which E-MAIL is selected will be described. By pressing an E-MAIL button 1311, the screen transitions to an E-MAIL setting screen 1320.

On the E-MAIL setting screen 1320, the destination setting, the scan setting, and the transmission setting can be configured. A check destination field 1321 displays the number of specified destinations. A reset button 1322 can be pressed to clear information. By pressing a transmission setting button 1323, settings related to transmitting such as scan size, file format, and double-sided original document can be configured. By pressing a start with black and white 1324 and a start with color 1325, scanning is performed with black-and-white reading or color reading, and transmitting via E-MAIL is started.

Performing the process described above reduces the time and effort required to share the image data transmitted by an image processing apparatus as an archive in chat services, while improving convenience for individual users.

### Third Embodiment

A third embodiment of the present disclosure will be described. In the third embodiment, the case where a chat message is also transmitted after transmitting an image will be described.

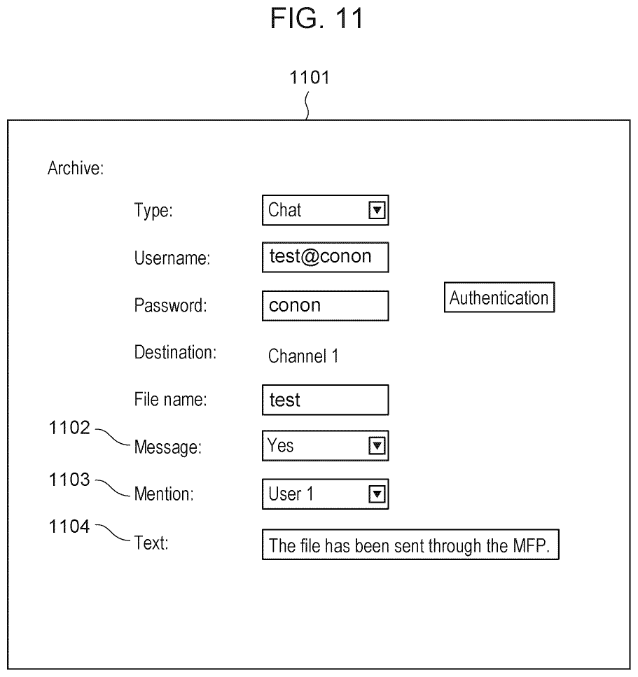

FIG. 11 illustrates a setting screen for archive transmitting, displayed using a remote UI function on the operation panel 201 of the user terminal 20. In the present embodiment, settings are configured on the user terminal 20. However, settings may be configured through the operating unit 116 of the MFP 10. The fields described in FIG. 7 will not be described.

In a message field 1102, whether to transmit a message after transmitting an image can be set.

To transmit a message, “Yes” is selected in the pull-down menu, otherwise “No” is selected.

In a mention field 1103, a setting for adding mention information to the message to be transmitted can be configured. The members belonging to the channel selected in the destination field can be selected from a pull-down menu. Mention information can be provided to a specific user in the group by additionally transmitting the mention information via chat. In a text field 1104, the message content to be transmitted can be set.

The message set on the setting screen 1101 can be transmitted with image data from the MFP 10 to the messaging application server 30 in S813. The messaging application server 30 posts the received message and image data to the designated channel.

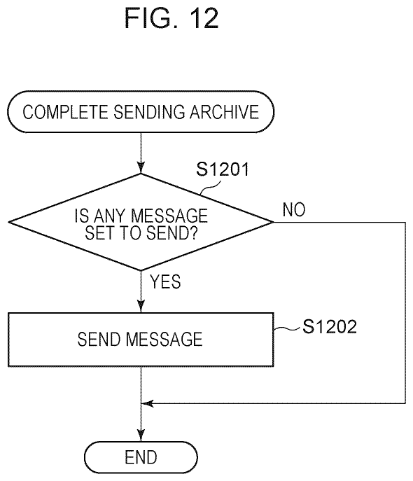

FIG. 12 is a flowchart illustrating a process performed by the MFP 10 when the MFP 10 transmits a message after archive transmitting to a business chat server in the present embodiment. The flow in FIG. 12 can be implemented by the CPU 111 loading the control program stored in the ROM 112 or the HDD 114 into the RAM 113 and executing the control program. The description of the archive transmitting process will not be repeated.

In S1201, the CPU 111 checks whether the setting in the message field 1102 is set to “Yes”. When the setting is set to “Yes”, the CPU 111 proceeds to S1202. When the setting is set to “No”, the CPU 111 ends the process.

In S1202, while attaching a mention when any setting is configured in the mention field 1103 or not attaching a mention when no setting is configured in the mention field 1103, the CPU 111 transmits the message registered in the text field 1104 via chat and ends the process.

Performing the process described above reduces the time and effort required to share the image data and message transmitted by an image processing apparatus as an archive in chat services.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-137006 filed Aug. 25, 2023, which is hereby incorporated by reference herein in its entirety.

What is claimed is:

1. An image processing apparatus comprising:
one or more processors and one or more memories, cooperating to:
scan an image of a document and generate image data;
transmit the generated image data to a destination specified by a user;
accept a designation of a channel of a chat service; and
transmit information about the designated channel and the generated image data to a server that provides the chat service, in response to the transmitting of the image data to the destination.

2. The image processing apparatus according to claim 1, wherein
the image data is posted to the designated channel as a result of the transmitting of the information about the designated channel and the generated image data to the server.

3. The image processing apparatus according to claim 1,
wherein the one or more processors and the one or more memories further cooperate to:
receive information about a plurality of channels of the chat service, and
accept the designation of the channel by accepting a selection by a user from the plurality of channels indicated by the received information about the plurality of channels.

4. The image processing apparatus according to claim 1,
wherein the one or more processors and the one or more memories further cooperate to:
register the information about the designated channel, and
register the information about the channel in association with a user of the image processing apparatus.

5. The image processing apparatus according to claim 1, wherein the one or more processors and the one or more memories further cooperate to transmit the information about the designated channel and the generated image data to the server, in response to completing the transmission of the image data to the destination.

6. The image processing apparatus according to claim 1, wherein the one or more processors and the one or more memories further cooperate to transmit the information about the designated channel and the generated image data to the server in response to the image processing apparatus receiving a notification indicating completion of transmitting of the image data to the destination.

7. The image processing apparatus according to claim 1, wherein the one or more processors and the one or more memories further cooperate to transmit to the server the information about the designated channel, the generated image data, and a message entered by a user, in response to the transmitting of the image data to the destination.

8. A non-transitory computer-readable storage medium storing one or more computer-executable programs, which when executed by a computer, cause the computer to perform a method comprising:
scanning an image of a document and generating image data;
transmitting the generated image data to a destination specified by a user;
accepting a designation of a channel of a chat service; and
transmitting of information about the designated channel and the generated image data to a server that provides the chat service, in response to the transmitting of the image data to the destination.

9. The non-transitory computer-readable storage medium according to claim 8, wherein
the image data is posted to the designated channel as a result of the transmitting of the information about the designated channel and the generated image data to the server.

10. The non-transitory computer-readable storage medium according to claim 8, the method further comprising:
receiving information about a plurality of channels of the chat service, wherein
the accepting includes accepting the designation of the channel by accepting a selection by a user from the plurality of channels indicated by the received information about the plurality of channels.

11. The non-transitory computer-readable storage medium according to claim 8, the method further comprising:
registering the information about the designated channel,
the registering including registering the information about the channel in association with a user of an image processing apparatus.

12. The non-transitory computer-readable storage medium according to claim 8, wherein
the information about the designated channel and the generated image data is transmitted to the server, in response to completion of transmitting of the image data to the destination.

13. The non-transitory computer-readable storage medium according to claim 8, wherein
the information about the designated channel and the generated image data is transmitted to the server, in response to receiving a notification indicating completion of transmitting of the image data to the destination.

14. The non-transitory computer-readable storage medium according to claim 8, wherein
the information about the designated channel, the generated image data, and a message entered by a user are transmitted to the server, in response to the transmitting of the image data to the destination.

15. An image processing method comprising:
scanning an image of a document and generating image data;
transmitting the generated image data to a destination specified by a user;
accepting a designation of a channel of a chat service; and
transmitting information about the designated channel and the generated image data to a server that provides the chat service, in response to the transmitting of the image data to the destination.
